(19) United States
(12) Patent Application Publication
(10) Pub. No.: US 2021/0331127 A1
(43) Pub. Date: Oct. 28, 2021

(54) MIXING AND DISPENSING CONTAINER

(71) Applicant: SDI (NORTH AMERICA), INC., Chicago, IL (US)

(72) Inventor: Joshua James CHEETHAM, Bayswater (AU)

(21) Appl. No.: 17/239,309

(22) Filed: Apr. 23, 2021

(30) Foreign Application Priority Data
Apr. 23, 2020 (AU) 2020901279
Mar. 9, 2021 (AU) 2021900666

(51) Int. Cl. B01F 13/00; B01F 3/12; B01F 15/02; B01F 11/00; B01F 15/00

(52) U.S. Cl. CPC B01F 13/0023; B01F 3/1242; B01F 3/1271; B01F 15/0237; B01F 2215/0027; B01F 15/00857; B01F 15/00993; B01F 2003/1257; B01F 11/0094

(57) ABSTRACT

A mixing and dispensing container for mixing and dispensing dental materials. The mixing and dispensing container includes: a plunger; an open-ended liquid receptacle adapted to receive the plunger; and a main body with a proximal end, a distal end, a chamber open at the proximal end and an aperture in the distal end. The chamber is adapted to receive the liquid receptacle. The dental capsule mixes various components of the dental materials and forms a dental paste for dispensing. The container is especially envisaged for use in mixing of components to provide a paste for dental use.

### FIELD OF THE INVENTION

The present invention relates to a mixing and dispensing container.

### BACKGROUND

In dentistry it is a common need to use compounds for procedures such as polishing, medicinal treatment, repairs and modifications. Dental compounds are often a mixture of components that form a paste and harden.

Known delivery mechanisms for this paste include mixing the components of a single liquid and a single powder and applying the paste via a swab or syringe. This process can be time-consuming and awkward, especially if the mixture is quick to set.

Dental compounds as above are difficult to perfectly and reproducibly mix, and prepare at a precise dosage. Some known mechanisms for mixing dental compounds are also susceptible to contaminating the dental compounds with foreign matter, and can be messy, affecting the hygiene of the preparation area.

Dental compounds are typically used in small quantities with small amounts of components. As such, conventional mixing means regularly have difficulty with uniform mixing, often forming lumps in the mixture making the application of the compound difficult. Furthermore, only a fraction of the mixed compound can be removed from the mixing location and applied to a treatment area with a significant percentage left as waste stuck to surfaces in the mixing area. Wastage of such material is costly and undesired.

Known capsules that contain only one liquid and one powder have very limited chemistries. For example, initiators for the liquid need to be contained in the powder which may not be practical. Furthermore, if two different initiators are needed for a liquid, these may not be able to be stored together in the powder component and thus the capsule may not be suitable.

The present invention attempts to overcome at least in part the aforementioned disadvantages of previous mixture delivery means.

### SUMMARY

In accordance with one aspect of the present invention there is provided a mixing and dispensing container for mixing and dispensing dental materials comprising:
a plunger;
an open-ended liquid receptacle adapted to receive the plunger; and
a main body with a proximal end, a distal end, a chamber open at the proximal end and an aperture in the distal end;
wherein the chamber is adapted to receive the liquid receptacle; and
wherein the dental capsule mixes various components of the dental materials and forms a dental paste for dispensing.

In a preferred embodiment, a liquid is housed within the liquid receptacle and a powder is housed within the chamber.

In a preferred embodiment, the liquid receptacle incorporates a centrally weakened portion.

In a preferred embodiment, the plunger has a forwardly projecting protrusion adapted to break the centrally weakened portion of the liquid receptacle. Preferably, the forwardly projecting protrusion achieves breakage through piercing.

In a preferred embodiment, the plunger is in engagement with the liquid receptacle such that upon the plunger being depressed liquid in the receptacle is pushed into the chamber.

In a preferred embodiment, further depression of the plunger results in a front portion of the liquid receptacle is broken away by depression of the plunger so as to push mixture of liquid and powder in the chamber through the aperture.

In a preferred embodiment, the dental capsule further comprises internal features that provide tactile feedback to an operator as to how far the plunger has been depressed, or how far the liquid receptacle has moved.

In a preferred embodiment, the dental capsule, or a portion thereof, is made from a transparent material allowing for an operator to view the mixing of liquids and/or powder, and/or how far the plunger has been depressed.

In a preferred embodiment, the dental capsule further comprises a nozzle connected to the aperture at the distal end of the main body.

In a preferred embodiment, the dental capsule further comprises, a frangible membrane covering the aperture at the distal end of the main body. More preferably, the frangible membrane which when broken provides access for an applicator device, such as a brush or swab, after mixing has been undertaken.

In a preferred embodiment, the chamber incorporates vent means for allowing entrapped air to escape from the mixed paste during extrusion.

In a preferred embodiment, the central weakened portion of the liquid receptacle has a thickness of less than 0.05 mm, and preferably less than 0.03 mm.

In a preferred embodiment, the central weakened portion of the liquid receptacle is formed of a unitary sheet of material that is integral to the liquid receptacle moulded part.

In a preferred embodiment, the frangible membrane has a thickness of less than 0.02 mm.

In a preferred embodiment, the frangible membrane is formed of a unitary sheet of material.

In a preferred embodiment, the dental capsule further comprises, a seal means located on an external surface of the plunger.

### BRIEF DESCRIPTION OF DRAWINGS

The present invention will now be described, by way of example, with reference to the accompanying drawings, in which:

FIG. 1 is a disassembled cross-sectional view of a mixing and dispensing container in accordance to an embodiment of the present invention.

FIG. 2a is a cross-sectional view of the embodiment of the mixing and dispensing container depicted in FIG. 1 in a first stage of use.

FIG. 2b is a cross-sectional view of the embodiment of the mixing and dispensing container depicted in FIG. 1 in a second stage of use.

FIG. 2c is a cross-sectional view of the embodiment of the mixing and dispensing container depicted in FIG. 1 in a third stage of use.

FIG. 2d is a cross-sectional view of the embodiment of the mixing and dispensing container depicted in FIG. 1 in a fourth stage of use.

FIG. 3 is a perspective cross-sectional view of a body for a mixing and dispensing container in accordance to an embodiment of the present invention depicted in FIG. 1.

FIG. 4 is a cross-sectional view of a body for a mixing and dispensing container in accordance to an embodiment of the present invention depicted in FIG. 1.

FIG. 5 is a perspective cross-sectional view of a first alternative body for a mixing and dispensing container.

FIG. 6 is a perspective cross-sectional view of a second alternative body for a mixing and dispensing container.

FIG. 7 is a cross-sectional view of a second alternative body for a mixing and dispensing container.

FIG. 8 is a collection of views of plungers in accordance to an alternative embodiment of the present invention with projections of various configurations.

FIG. 9 is a pair of side views of plungers in accordance to an alternative embodiment of the present invention with projections of various configurations

FIG. 10 is a perspective view of a plunger in accordance to an alternative embodiment of the present invention with an alternative projection

FIG. 11 is a perspective view and top view of a plunger in accordance to an alternative embodiment of the present invention with an alternative projection.

### DETAILED DESCRIPTION

The embodiments described below provide a mixing and dispensing container, comprising:
a plunger;
an open-ended liquid receptacle adapted to receive the plunger; and
a main body with a proximal end, a distal end, a chamber open at the proximal end and an aperture in the distal end;
wherein the chamber is adapted to receive the liquid receptacle; and
wherein the dental capsule mixes various components of the dental materials and forms a dental paste for dispensing.

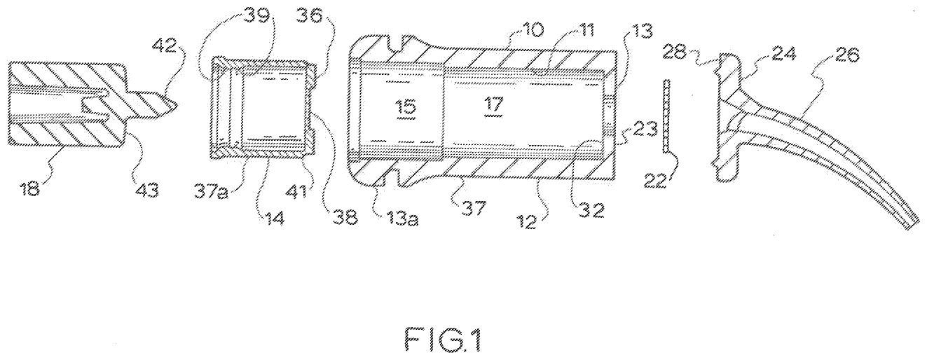

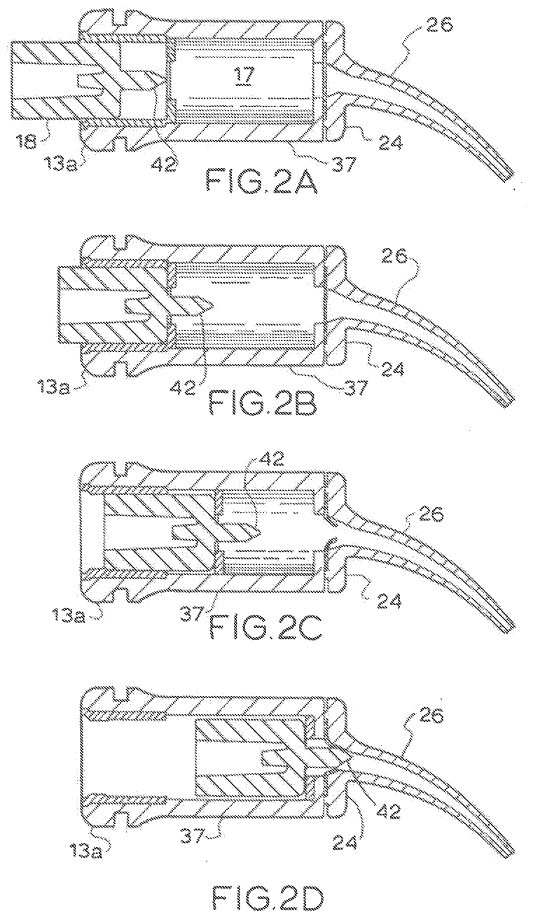

Referring to the FIGS. 1 through 2d of the accompanying drawings there is shown a container that is particularly envisaged to be used for dispensing of a dental material, in which a front portion of a liquid receptacle may be entirely detached from the liquid receptacle.

In FIG. 1 of the accompanying drawings there is shown a container 10 in a disassembled condition. The dental container 10 comprises a body 12 which has an internal surface 11 and is substantially cylindrical in cross section. Inside the body 12 is an open-ended liquid receptacle chamber 15, which is arranged to contain a liquid receptacle 14. The receptacle 14 is sealed by a plunger 18 such as by one or more seals 39 located on an internal surface of the receptacle 14 or on an external surface of the plunger 18.

The plunger 18 is initially located in an open end of the receptacle 14 and has a front face 43.

Further, the front face 43 of the plunger 18 has extending therefrom a forwardly projecting protrusion 42.

The body 12 contains a main chamber 17 which is arranged to house an amount of powder. The main chamber 17 of the body 12 is sealed at a distal end 13 by a frangible membrane 22 which is connected over an aperture and to the body 12 by any convenient means such as an adhesive. The distal end 13 of the body 12 is opposed to a proximal end 13a thereof. The body 12 has attached thereto over the aperture an end cap 24 which is connected to a nozzle 26 for dispensing material.

The liquid receptacle 14 has a side wall 37a joined at an edge 41 to an inner front portion 36 having a central weakened portion 38. The central weakened portion 38 is substantially thinner than the remainder of the front portion 36 of the liquid receptacle 14.

In relation to FIGS. 2a and 2b of the accompanying drawings, there is shown the container 10 in an activated condition. This is achieved by means of the plunger 18 being depressed. This action causes the plunger 18 to be moved so that initially the sharp protrusion 42 engages with and then pierces the weakened section 38 of the front portion 36. The plunger then moves forward until the front face 43 thereof engages with the front portion 36 and displaces the liquid hydraulically. The liquid is thus forced through a small hole in the weakened section 38 around the protrusion 42 formed by the piercing action into the main chamber 17 of the body 12 by the front face 43. The container 10 may then be placed into a known vibrating mixing device. The liquid and the powder are admixed and thereby form a paste in the chamber 17.

Referring to FIGS. 2c and 2d, there is shown the container 10 after the plunger 18 has been depressed and the liquid and the powder have been mixed to form a paste. The main chamber 17 of the body 12 now contains the paste. The front portion 36 of the liquid receptacle 14 has broken away at edge 41 from the remainder of the liquid receptacle 14.

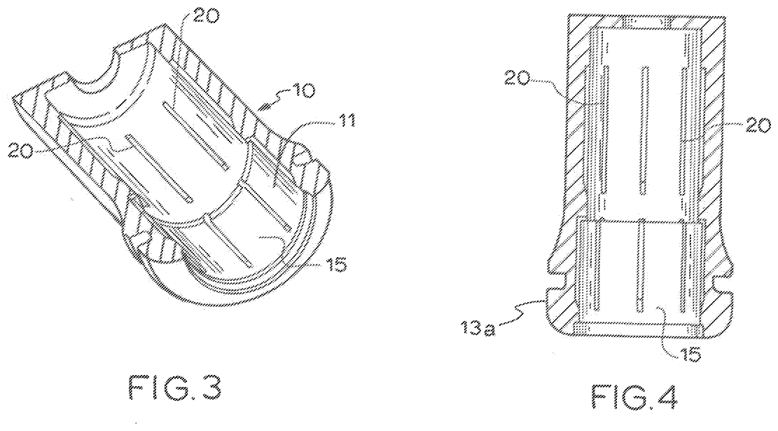

The plunger 18 forces the front portion 36 of the liquid receptacle 14 along the main chamber 17, where the front portion 36 of the liquid receptacle 14 acts as a seal and prevents paste from travelling rearwardly. As shown in FIGS. 3 and 4, a vent feature such as slots 20 located in the main body internal wall 11 may be provided to act as vent means for entrapped air to escape from the powder.

As the plunger 18 is displaced forwardly, hydraulic pressure on the paste bursts the membrane 22, allowing fluid communication between the main chamber 17 and the nozzle 26 and subsequent dispensing of the paste to a desired location.

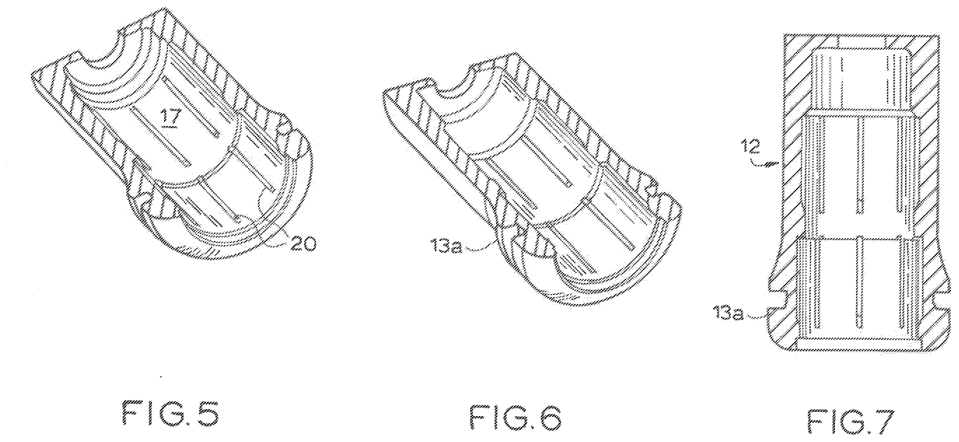

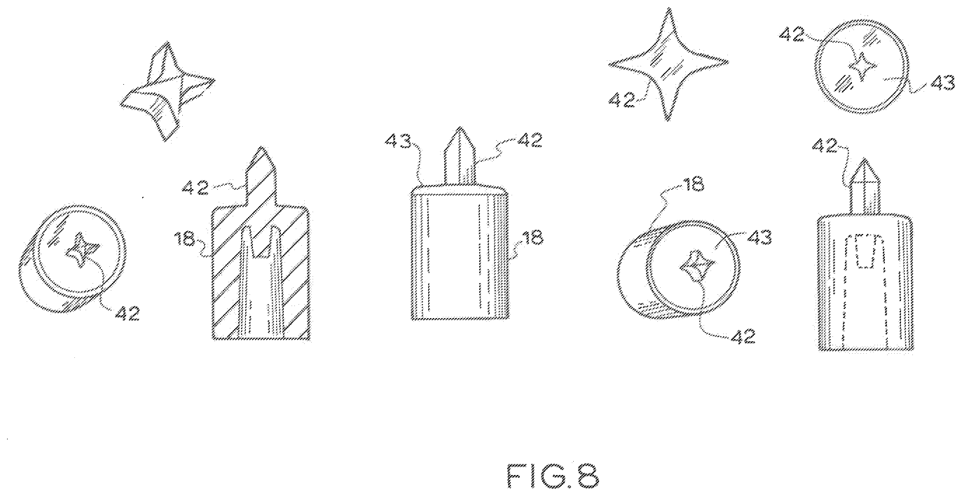

In FIGS. 5 to 7 of the accompanying drawings, there are shown variations of the container 10 in cross sections. Further, in FIG. 8 of the accompanying drawings the projections 42 which have various configurations which may be star shaped in cross sections or the like.

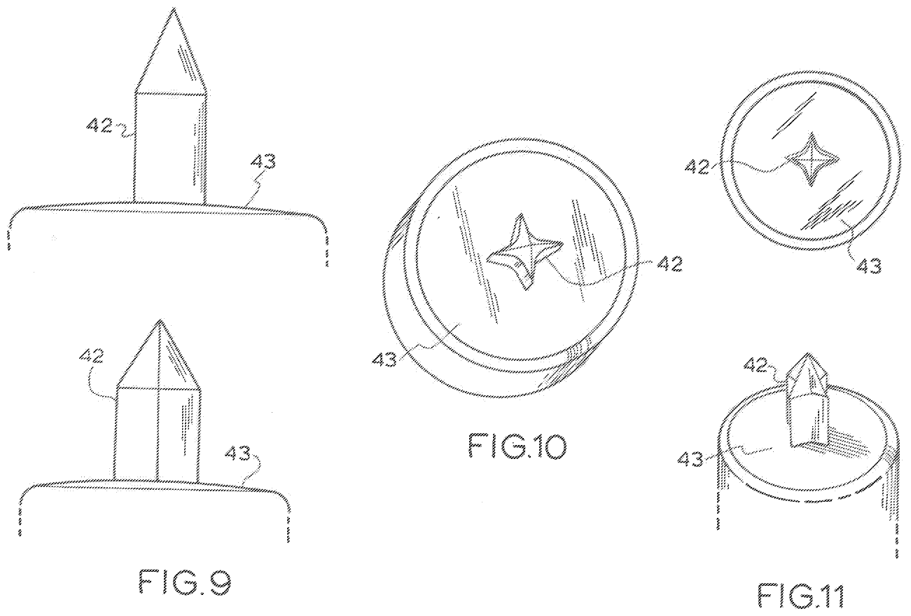

In FIGS. 9, 10 and 11 there are shown projections 42, which are welded to the front face 43 of plunger 18.

Modifications and variations as would be apparent to a skilled addressee are deemed to be within the scope of the present invention.

1. A mixing and dispensing container for mixing and dispensing dental materials comprising:
a plunger;
an open-ended liquid receptacle adapted to receive the plunger; and
a main body with a proximal end, a distal end, a chamber open at the proximal end and an aperture in the distal end;
wherein the chamber is adapted to receive the liquid receptacle; and
wherein, in use, the dental capsule mixes various components of the dental materials and forms a dental paste for dispensing.

2. The mixing and dispensing container of claim 1, wherein a liquid is housed within the liquid receptacle and a powder is housed within the chamber.

3. The mixing and dispensing container of claim 1, wherein the liquid receptacle comprises a centrally weakened portion.

4. The mixing and dispensing container of claim 3, wherein the plunger has a forwardly projecting protrusion adapted to break the centrally weakened portion of the liquid receptacle.

5. The mixing and dispensing container of claim 4, wherein the plunger is in engagement with the liquid receptacle such that upon the plunger being depressed the liquid in the receptacle is pushed into the chamber.

6. The mixing and dispensing container of claim 5, wherein further depression of the plunger results in a front portion of the liquid receptacle being broken away by depression of the plunger so as to push mixture of liquid and powder in the chamber through the aperture.

7. The mixing and dispensing container of claim 6, wherein the dental capsule further comprises internal features that provide tactile feedback to an operator as to how far the plunger has been depressed, or how far the liquid receptacle has moved.

8. The mixing and dispensing container of claim 6, wherein the dental capsule, or a portion thereof, is made from a transparent material allowing for an operator to view the mixing of liquids and/or powder, and/or how far the plunger has been depressed.

9. The mixing and dispensing container of claim 1 wherein the dental capsule further comprises a nozzle connected over the aperture at the distal end of the main body.

10. The mixing and dispensing container of claim 1, wherein the dental capsule further comprises a frangible membrane covering the aperture.

11. The mixing and dispensing container of claim 1, wherein, the chamber comprises a vent feature for allowing entrapped air to escape from the mixed paste during extrusion.

12. The mixing and dispensing container of claim 3, wherein the central weakened portion of the liquid receptacle has a thickness of less than 0.05 mm.

13. The mixing and dispensing container of claim 12 wherein, the central weakened portion of the liquid receptacle has a thickness of less than 0.03 mm.

14. The mixing and dispensing container of claim 3, wherein the central weakened portion of the liquid receptacle is formed of a unitary sheet of material that is integral to the liquid receptacle.

15. The mixing and dispensing container of claim 10, wherein the frangible membrane has a thickness of less than 0.02 mm.

16. The mixing and dispensing container of claim 10, wherein the frangible membrane is formed of a unitary sheet of material.

17. The mixing and dispensing container of claim 1, wherein the dental capsule further comprises a seal located on an external surface of the plunger.
